(19) United States
(12) Patent Application Publication
(10) Pub. No.: US 2010/0052394 A1
(43) Pub. Date: Mar. 4, 2010

(54) ACTUATING DEVICE FOR A VEHICLE SEAT

(76) Inventors: Norbert HEEG, Dahn (DE); Peter MÜLLER, Mackenbach (DE)

Correspondence Address: MCGLEW & TUTTLE, PC, P.O. BOX 9227, SCARBOROUGH STATION, SCARBOROUGH, NY, 10510-9227, US

(21) Appl. No.: 12/547,011

(22) Filed: Aug. 25, 2009

(30) Foreign Application Priority Data
Aug. 28, 2008 (DE) 10 2008 045 350.1

(51) Int. Cl. B60N 2/20; B60N 2/02

(52) U.S. Cl. 297/378.13

(57) ABSTRACT

An actuating device (50) is provided for a vehicle seat, in particular for a motor vehicle seat. The actuating device includes a holder (51), a manually drivable actuating handle (52), a shaft (53) mounted rotatably in the holder (51), which is connected to the actuating handle (52) and may be driven thereby, and an output (55) connected fixedly in terms of rotation to the shaft (53). The shaft (53) may also be driven by a motor (59). The motor (59) and the shaft (53) are able to be coupled to one another and decoupled from one another by means of a wrap spring (57).

### CROSS REFERENCE TO RELATED APPLICATIONS

This application claims the benefit of priority under 35 U.S.C. §119 of German Patent Application DE 10 2008 045 350.1 filed Aug. 28, 2008, the entire contents of which are incorporated herein by reference.

### FIELD OF THE INVENTION

The invention relates to an actuating device for a vehicle seat, in particular for a motor vehicle seat, the actuating device including a holder, a manually drivable actuating handle, a shaft mounted rotatably in the holder, which is connected to the actuating handle and may be driven thereby, and an output connected fixedly in terms of rotation to the shaft.

### BACKGROUND OF THE INVENTION

Actuating devices of this type, which are used for unlocking backrests in rear seat systems, are known from use. A partially open housing is provided as a holder, in which an actuating handle is mounted by means of a shaft formed by two pins formed thereon. By means of an output connected fixedly in terms of rotation to the shaft, a locking device configured as a backrest lock may be unlocked via a coupling gear. A development to a remote unlocking system, for example from the luggage compartment, requires a complicated construction which has a considerable influence on the actuating forces.

### SUMMARY OF THE INVENTION

The object of the invention is to improve an actuating device of the aforementioned type. This object is achieved according to the invention by an actuating device comprising a holder, a manually drivable actuating handle, a shaft mounted rotatably in the holder, which is connected to the actuating handle and may be driven thereby and an output connected fixedly in terms of rotation to the shaft. The shaft may also be driven by a motor. The motor and the shaft are able to be coupled to one another and decoupled from one another by means of a wrap spring.

The possibility of driving the shaft both manually and by motor markedly reduces the complexity for the unlocking system, in particular for an additional remote unlocking system. Integration is possible in a network for controlling a rear seat system. The manual drive and the motorized drive are coupled to one another and decoupled from one another by means of a simple wrap spring. The wrap spring is wrapped around the shaft. When the motor starts to operate, a non-positive connection between the motor and shaft is automatically produced by pulling the wrap spring. To this end, the wrap spring ends are initially rotated counter to one another via an idle stroke. If the non-positive connection between the wrap spring and the shaft has reached a sufficient level of transmission, the motor drives the shaft by means of a gear stage and the wrap spring. If no torque is applied from the motor side, the wrap spring relaxes and expands due to its spring tension. Thus a decoupling is produced. Due to the decoupling, the mechanism may be reset within the locking device or possibly the adjusting drive, without the magnetic latching torque of the motor having to be overcome.

The actuating device according to the invention may be used at different points of a vehicle seat, for example for actuating a locking device which is provided for connecting the entire vehicle seat to the floor or as a backrest lock for fastening the backrest to the vehicle structure, or for driving a seat adjusting device. The actuating device may also be used elsewhere in the vehicle.

The invention is described in more detail hereinafter with reference to an embodiment shown in the drawings. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a schematic, sectional view of the embodiment with a manual drive, with the flux of force illustrated;

FIG. 2 is a view according to FIG. 1 with the motorized drive, with the flux of force illustrated;

FIG. 3 is a view according to FIG. 1 in the case of torque introduced on the output side, with the flux of force illustrated;

FIG. 4 is a sectional view taken through a locking device to be actuated, in the locked state with the counter element indicated;

FIG. 5 is a sectional view according to FIG. 4 in the unlocked state;

FIG. 6 is a section along the line VI-VI in FIG. 4; and

FIG. 7 is a schematic view of a vehicle seat with actuating device according to the invention.

### DESCRIPTION OF THE PREFERRED EMBODIMENTS

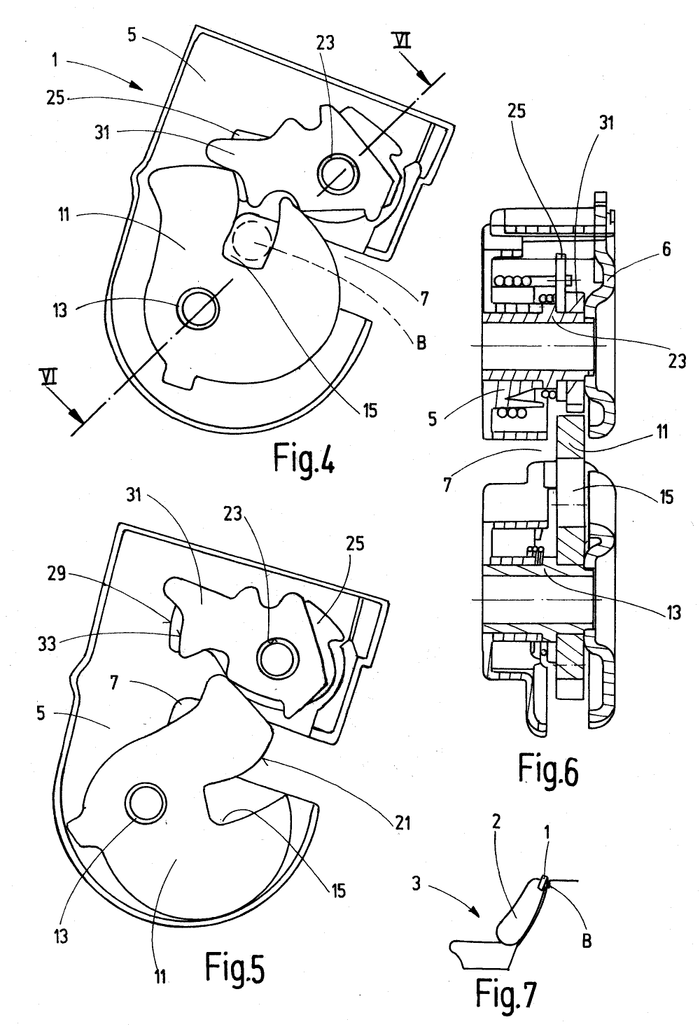

Referring to the drawings in particular, In a motor vehicle, a locking device 1 is provided for connecting a backrest 2 of a vehicle seat 3 to the vehicle structure (FIGS. 4-6). The locking device 1 has a half-open housing 5 with an approximately planar bottom surface and raised edges. The bottom surface is generally arranged in a plane defined by the direction of travel of the motor vehicle and by the vertical, which defines the directional information subsequently used. The housing 5 is substantially closed by a cover 6, which bears against the housing 5 approximately parallel to the bottom surface and is connected thereto. The housing 5 and/or the cover 6 may, for example, be formed from metal or plastics material, possibly with metallic insert parts. The cover 6 may also be integrated in the structural parts of the vehicle seat 3 or the vehicle structure.

The housing 5 and the cover 6 form a receiver 7, which opens in the direction of a counter element B, in order to receive said counter element for locking. In this connection, of the locking device 1 and the counter element B, one is fastened to the structure of the backrest 2 and the other to the vehicle structure. The counter element B may, for example, be a pin or a clip. The portion of the counter element B received by the receiver 7 generally extends horizontally. The direction in which the counter element B is received by the receiver 7 is denoted as the insertion direction. The dimensions of the receiver 7 perpendicular to the insertion direction (and in the plane of the bottom surface of the housing 5) are preferably greater than the corresponding diameter of the counter element B, for the compensation of play.

A pawl 11 is pivotably mounted on a first bearing pin 13, which in turn is fastened to the housing 5 (and to the cover 6) and projects perpendicularly from the bottom surface thereof, i.e. extends horizontally. The first bearing pin 13 is preferably of hollow configuration in order to receive a fastening means, for example a screw, by means of which the locking device 1 is fastened during mounting to the associated structure. The pawl 11 has a hook opening 15 for cooperating with the counter element B.

In the closed position of the pawl 11, the hook opening 15 crosses the receiver 7 approximately vertically and opens towards the side. The dimensions of the hook opening 15 aligned in the insertion direction are slightly greater than the diameter of the counter element B, as a result of which the counter element B in the locked state of the locking device 1 does not bear against the edge of the hook opening 15 located further inside in the insertion direction but at the bottom of the receiver 7 on the housing 5. In the open position of the pawl 11, the hook opening 15 opens obliquely to the insertion direction and crosses the receiver 7 obliquely. The pawl 11 may be pretensioned in the direction of the open position.

The pawl 11 has a functional surface 21 which in the locked position faces approximately in the direction of a second bearing pin 23, which is arranged parallel to the first bearing pin 13 and is fastened in the same manner to the housing 5 (and to the cover 6). The functional surface 21 is, for example, curved in the manner of a circular arc and is of concave configuration but may also be planar. On the second bearing pin 23, a tensioning element 25 is pivotably mounted which is pretensioned towards the pawl 11. In the locked state and in the normal case, the tensioning element 25 exerts a closing moment on the pawl 11 as a securing element, by means of a tensioning surface 29 which is curved eccentrically relative to the second bearing pin 23 and which is in contact with the functional surface 21 in a non-self locking manner. The tensioning surface 29 is, for example, curved in the manner of a circular arc and is of convex configuration.

A catch element 31 is arranged axially (relative to the second bearing pin 23) adjacent to the tensioning element 25 on the side remote from the housing 5, and also pivotably mounted on the second bearing pin 23 i.e. mounted about a common pivot axis, aligned with the tensioning element 25. The catch element 31 has a catch surface 33 which is located in the vicinity of the tensioning surface 29 but in the locked state is spaced apart from the functional surface 21. The catch surface 33 is, for example, curved in the manner of a circular arc and is of convex configuration but may also be planar. The catch element 31 may be mounted in its center of gravity. The catch element 31 and the tensioning element 25 are coupled for entrainment to an idle path, for example by means of a slot-pin-guide or an axially protruding drive element. In the event of a crash, if the pawl 11 possibly performs an opening moment and slightly pushes away the tensioning element 25, the catch surface 33 comes to bear against the functional surface 21 without an opening moment being able to be transmitted. Thus the catch element 31 serves for supporting the pawl 11 and, as a further securing element, prevents an opening thereof.

In the locked state of the locking device 1 (FIG. 4) the counter element B is located in the receiver 7 and in the hook opening 15 of the closed pawl 11, the tensioning element 25 secures the pawl 11 and the catch element 31 is slightly spaced apart from the functional surface 21. In order to unlock the locking device 1, the securing elements 25 and 31 have to be moved away from the pawl 11. If the catch element 31 is pivoted, the catch surface 33 moves away from the functional surface 21. The pivoting catch element 31 drives the tensioning element 25 so that the pawl 11 is no longer secured. Driven by one of the two securing elements or by inherent pretensioning, the pawl 11 opens. Due to the pivoting movement of the pawl 11, the hook opening 15 pulls back from the receiver 7 and releases the counter element B which moves away relative to the locking device 1 counter to the insertion direction. Preferably, in the unlocked state of the locking device 1, the pawl 11 and the catch element 31 bear against one another for mutual support, at a point which is respectively different from the functional surface 21 and the catch surface 33, so that the hook opening 15 remains ready to receive.

If, in this unlocked state (FIG. 5), the counter element B again reaches the receiver 7 and comes to bear against the edge of the hook opening 15, the counter element B forces the pawl 11 into its closed position. The tensioning element 25 moves (due to its pretensioning) along the functional surface 21, as does the catch element 31 driven by the tensioning element 25 or pivoting due to inherent pretensioning, whereby said two securing elements again secure the pawl 11. The locking device 1 has then been automatically locked.

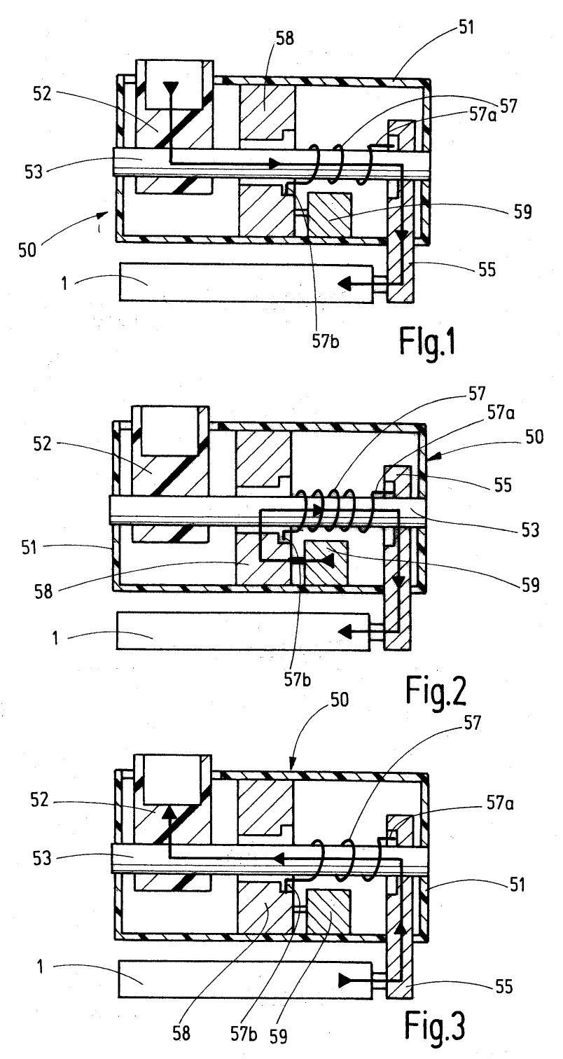

According to the invention, an actuating device 50 is provided (FIGS. 1-3) by means of which the locking device 1 may be unlocked, optionally manually or by motor. The actuating device 50 has a holder 51 on which an actuating handle 52 is pivotably mounted by means of a shaft 53. The holder 51 is preferably fixedly connected to the housing 5, for example directly or via further structural parts of the vehicle seat 3 or the vehicle structure. The actuating handle 52 may, for example, be configured as a rotary handle with a depression or as a lever. The shaft 53 is, on the one hand, connected fixedly in terms of rotation to the actuating handle 52 and, on the other hand, fixedly in terms of rotation to an output 55 of the actuating device 50. The output 55 is configured as a lever and is connected in an articulated manner to the catch element 31, for example by means of a single point of articulation, by means of a coupling gear, by means of a cable pull and in any other manner known per se. Alternatively, the output 55 is integrally formed with the actuating handle 52. If the output 55 pivots, the catch element 31 also pivots.

On the shaft 53 is arranged a wrap spring 57, preferably axially between the actuating handle 52 and the output 55. The wrap spring 57 is wrapped around the shaft 53 and has an opening wrap spring end 57a, and a closing wrap spring end 57b. At the opening wrap spring end 57a the wrap spring 57 is fastened to the output 55, for example suspended. The closing wrap spring end 57b is fastened to the output of a gear stage 58, for example suspended, with or without clearance or with clearance on one side. The gear stage 58 reduces the rotation of a motor 59. The gear stage 58 driven by the motor 59, as well as the motor 59 driving said gear stage, are preferably also mounted on the holder 51.

The wrap spring 57 decouples the motorized unlocking from the manual unlocking. In the locked state of the locking device 1 the wrap spring 57 is loosely wrapped around the shaft 53. If the actuating handle 52 is manually pivoted (FIG. 1) and thus the shaft 53 is rotated, the wrap spring 57 remains unaffected. If via the output 55 a torque is introduced into the actuating device 50 (FIG. 3), the wrap spring 57—depending on the fastening of the opening wrap spring end 57a and the pivoting direction of the output 55—is either not acted upon at all (in the case of fastening with clearance or one-sided clearance in said pivoting direction of the output 55) or opened further (in the case of fastening without clearance or no clearance in said pivoting direction of the output 55). This case of torque introduced on the output side occurs, in particular, when the locking device 1 is automatically locked and the catch element 31 returns into the position in which it secures the pawl 11. If the motor 59 drives the gear stage 58, the closing wrap spring end 57b is acted upon. The wrap spring 57 is pulled tightly, positions itself in a frictionally engaged manner around the shaft 53 and drives said shaft (FIG. 2). As a result, the gear stage 58 drives the shaft 53, which in turn unlocks the locking device 1 by means of the output 55.

In a modified embodiment, the wrap spring 57 is provided between the motor 59 and the gear stage 58, in particular on a connecting shaft between the two.

In a further embodiment which is not shown in the drawings, the actuating device 50, instead of the locking device 1, drives a seat adjusting device, for example a backrest inclination adjuster, the actuating handle 52 then preferably being configured as a hand wheel and the shaft 53 being designed for a plurality of rotations. Also in this case, by means of the wrap spring 57 a decoupling takes place between the gear stage 58 and the driven seat adjusting device, in the event of torques introduced from the output side.

While specific embodiments of the invention have been described in detail to illustrate the application of the principles of the invention, it will be understood that the invention may be embodied otherwise without departing from such principles.

### Appendix

### List of Reference Numerals

1 Locking device

2 Backrest

3 Vehicle seat

5 Housing

6 Cover

7 Receiver

11 Pawl

13 First bearing pin

15 Hook opening

21 Functional surface

23 Second bearing pin

25 Tensioning element

29 Tensioning surface

31 Catch element

33 Catch surface

50 Actuating device

51 Holder

52 Actuating handle 53 Shaft 55 Output 57 Wrap spring 57a Opening wrap spring end 57b Closing wrap spring end 58 Gear stage 59 Motor B Counter element

What is claimed is:

1. An actuating device for a vehicle seat, the actuating device comprising:
a holder;
a manually drivable actuating handle;
a shaft mounted rotatably in the holder, the shaft being connected to the actuating handle and being driven thereby;
an output connected fixedly in terms of rotation to the shaft;
a motor for also driving the shaft; and
a wrap spring, the motor and the shaft being coupled to one another and decoupled from one another by means of the warp spring.

2. An actuating device according to claim 1, wherein the wrap spring is wrapped around the shaft and has an opening wrap spring end and a closing wrap spring end.

3. An actuating device according to claim 2, wherein the opening wrap spring end is fastened to the output.

4. An actuating device according to claim 2, wherein the closing wrap spring end is fastened to an output of the motor or a gear stage driven by the motor.

5. An actuating device according to claim 3, wherein the closing wrap spring end is fastened to an output of the motor or a gear stage driven by the motor.

6. An actuating device according to claim 5, wherein the motor and/or the gear stage driven by the motor are mounted on the holder.

7. An actuating device according to claim 1, wherein the motor and/or a gear stage driven by the motor are mounted on the holder.

8. A system comprising:
an actuating device comprising holder, a manually drivable actuating handle, a shaft mounted rotatably in the holder, the shaft being connected to the actuating handle and being driven thereby, an output connected fixedly in terms of rotation to the shaft, a motor for also driving the shaft and a wrap spring, the motor and the shaft being coupled to one another and decoupled from one another by means of the warp spring; and
a locking device actuated by the actuating device or actuated by a driven seat adjusting device.

9. A system according to claim 8, wherein the locking device cooperates with a counter element and automatically locks when receiving the counter element.

10. A system according to claim 9, wherein the locking device has a housing, a pawl movably mounted on the housing for locking to the counter element and at least one securing element provided in the locked state for securing the pawl which is movable relative to the pawl for unlocking the locking device.

11. A system according to claim 10, wherein the output of the actuating device drives the securing element.

12. A vehicle seat system comprising:
a vehicle seat with a backrest;
an actuating device comprising holder, a manually drivable actuating handle, a shaft mounted rotatably in the holder, the shaft being connected to the actuating handle and being driven thereby, an output connected fixedly in terms of rotation to the shaft, a motor for also driving the shaft and a wrap spring, the motor and the shaft being coupled to one another and decoupled from one another by means of the warp spring; and
a locking device actuated by the actuating device or actuated by a driven seat adjusting device, the locking device for connecting a vehicle seat backrest with respect to a vehicle structure.

13. A vehicle seat system according to claim 12, wherein the locking device cooperates with a counter element and automatically locks when receiving the counter element.

14. A vehicle seat system according to claim 12, wherein the locking device has a housing, a pawl movably mounted on the housing for locking to the counter element and at least one securing element provided in the locked state for securing the pawl which is movable relative to the pawl for unlocking the locking device.

15. A vehicle seat system according to claim 12, wherein the output of the actuating device drives the securing element.
